(19) United States
(12) Patent Application Publication
(10) Pub. No.: US 2017/0023822 A1
(43) Pub. Date: Jan. 26, 2017

(54) DISPLAY DEVICE

(71) Applicant: Samsung Display Co., Ltd., Yongin-si (KR)

(72) Inventors: Sujeong KIM, Yongin-si (KR); Yeuntae KIM, Yongin-si (KR); Sunyoung CHANG, Yongin-si (KR); Seokjoon HONG, Yongin-si (KR)

(21) Appl. No.: 14/990,122

(22) Filed: Jan. 7, 2016

(30) Foreign Application Priority Data
Jul. 22, 2015 (KR) 10-2015-0103876

(51) Int. Cl. G02F 1/1333; G02F 1/1337; G02F 1/1368; G02F 1/1343; G02F 1/1362; G02F 1/1335; G02F 1/1341

(52) U.S. Cl. CPC G02F 1/133377; G02F 1/133514; G02F 1/133711; G02F 1/1341; G02F 1/134309; G02F 1/13439; G02F 1/136227; G02F 1/136286; G02F 1/1368; G02F 1/133512; G02F 1/133345; G02F 2001/133742

(57) ABSTRACT

A display device includes a pixel electrode disposed in a pixel region and a light-shielding member partially overlapping the pixel electrode. A roof layer faces the pixel electrode. The roof layer includes a color filter and a pillar portion extending toward the light-shielding member. A cavity is formed between the pixel electrode and the roof layer. A common electrode is disposed on the roof layer. An inlet exposes a portion of the cavity. A controllable material is disposed in the cavity. A cover layer seals the inlet. The light-shielding member includes a first region corresponding to the pillar portion and a second region adjacent to the first region. A thickness of the first region is different from a thickness of the second region.

### CROSS-REFERENCE TO RELATED APPLICATION

This application claims priority from and the benefit of Korean Patent Application No. 10-2015-0103876, filed on Jul. 22, 2015, which is hereby incorporated by reference for all purposes as if fully set forth herein.

### BACKGROUND

Field

Exemplary embodiments relate to a display device.

Discussion

Liquid crystal display (LCD) devices are widely used, and typically include two display panels with a liquid crystal (LC) layer disposed therebetween. The two display panels may include electric field-generating electrodes, such as a pixel electrode and a common electrode. The LCD device may generate an electric field in the LC layer by applying a voltage to the electric field-generating electrodes. The generation of the electric field may control the alignment of LC molecules of the LC layer. The controlled alignment of the LC molecules may control light (e.g., the polarization of light) propagating through the LC layer to, thereby, enable the display of an image.

Instead of two display panels, an LCD device may include one display panel including cavities formed on a pixel-by-pixel basis. The cavities may be filled with an LC material. The cavities formed on a pixel-by-pixel basis are very small as compared to the space between two display panels typically occupied by a LC layer. As such, technology to fill the cavities with sufficient amounts of LC material, while meeting the requirements (for example, light leakage prevention, electrode insulation, etc.) for securing display quality is required.

The above information disclosed in this Background section is only for enhancement of understanding of the background of the inventive concept, and, therefore, it may contain information that does not form the prior art that is already known in this country to a person of ordinary skill in the art.

### SUMMARY

One or more exemplary embodiments provide a display device configured to prevent (or at least reduce) defective dropping of a controllable material (e.g., liquid crystal material), as well as configured to prevent (or at least reduce) light leakage and short circuiting between a pixel electrode and a common electrode.

Additional aspects will be set forth in part in the detailed description which follows, and, in part, will be apparent from the disclosure, or may be learned by practice of the inventive concept.

According to one or more exemplary embodiments, a display device includes a pixel electrode disposed in a pixel region and a light-shielding member partially overlapping the pixel electrode. A roof layer faces the pixel electrode. The roof layer includes a color filter and a pillar portion extending toward the light-shielding member. A cavity is formed between the pixel electrode and the roof layer. A common electrode is disposed on the roof layer. An inlet exposes a portion of the cavity. A controllable material is disposed in the cavity. A cover layer seals the inlet. The light-shielding member includes a first region corresponding to the pillar portion and a second region adjacent to the first region. A thickness of the first region is different from a thickness of the second region.

According to one or more exemplary embodiments, a display device includes: a pixel electrode disposed in a pixel region; a light-shielding member partially overlapping the pixel electrode; and a roof layer facing the pixel electrode. The roof layer includes a pillar portion extending toward the light-shielding member. A cavity is formed between the pixel electrode and the roof layer. A common electrode is disposed on the roof layer. A controllable material is disposed in the cavity. The light-shielding member includes a protrusion portion protruding toward the pillar portion.

According to one or more exemplary embodiments, a display device may prevent (or at least reduce) defective dropping of the controllable material (e.g., liquid crystal material), as well as prevent (or at least reduce) a short circuit between a pixel electrode and a common electrode. One or more exemplary embodiments may also prevent (or at least reduce) light leakage using a light-shielding member having different thicknesses at various regions.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a plan view of a pixel of a liquid crystal display device, according to one or more exemplary embodiments.

FIG. 2 is a cross-sectional view of the pixel of FIG. 1 taken along sectional line II-II, according to one or more exemplary embodiments.

FIG. 3 is a cross-sectional view of the pixel of the FIG. 1 taken along sectional line according to one or more exemplary embodiments.

FIG. 4 is a cross-sectional view of the pixel of FIG. 1 taken along sectional line IV-IV, according to one or more exemplary embodiments.

FIGS. 5 to 28 are respective cross-sectional views of a pixel at various stages of manufacture, according to one or more exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

Unless otherwise specified, the illustrated exemplary embodiments are to be understood as providing exemplary features of varying detail of various exemplary embodiments. Therefore, unless otherwise specified, the features, components, modules, layers, films, panels, regions, processes, and/or aspects of the various illustrations may be otherwise combined, separated, interchanged, and/or rearranged without departing from the disclosed exemplary embodiments. For example, two consecutively described processes may be performed substantially at the same time or performed in an order opposite to the described order. Further, in the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms “first,” “second,” etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Although various exemplary embodiments are described with respect to liquid crystal display devices, it is contemplated that various exemplary embodiments are also applicable to other display devices, such as, for example, electrophoretic displays, electrowetting displays, plasma displays, and the like.

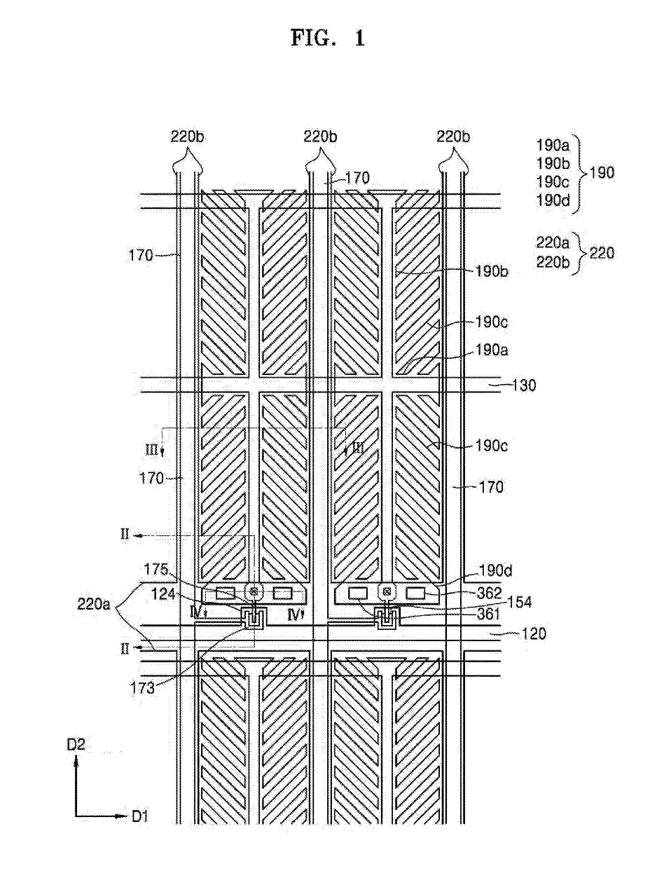

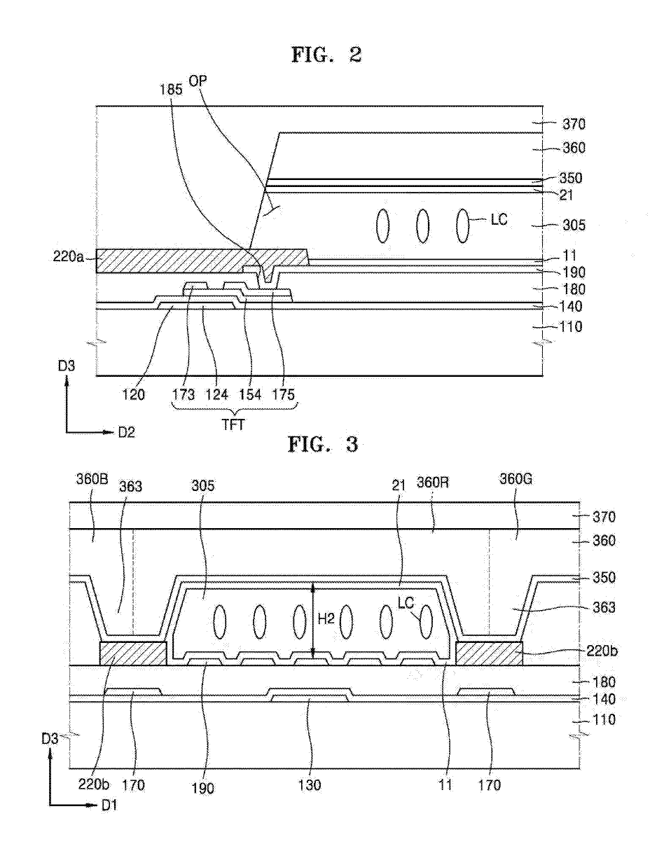

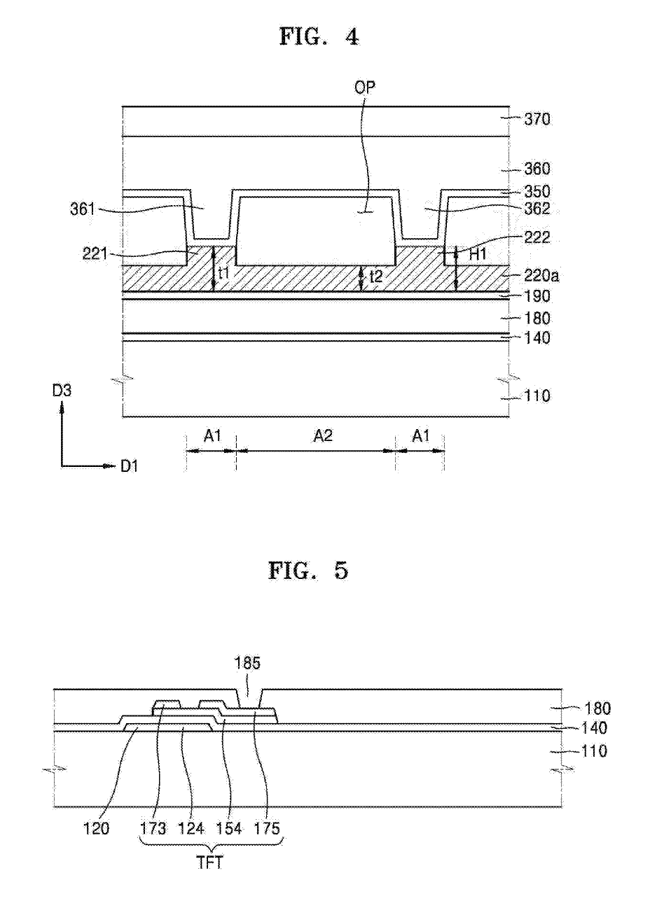

FIG. 1 is a plan view of a pixel of a liquid crystal display device, according to one or more exemplary embodiments. FIG. 2 is a cross-sectional view of the pixel of FIG. 1 taken along sectional line II-II, FIG. 3 is a cross-sectional view of the pixel of FIG. 1 taken along sectional line III-III and FIG. 4 is a cross-sectional view of the pixel of FIG. 1 taken along sectional line IV-IV, according to one or more exemplary embodiments.

Referring to FIGS. 1 to 4, the liquid crystal display device includes a gate line 120 and a data line 170 disposed on a substrate 110 including a material, such as a glass material, a plastic material, etc. The gate line 120 extends along a first direction D1, the data line 170 extends along a second direction D2 crossing the first direction D1, and a pixel region is defined in association with an intersection where the gate line 120 crosses the data line 170. A portion of the gate line 120 protrudes to form a gate electrode 124, and a portion of the data line 170 protrudes to form a source electrode 173.

A storage electrode 130 is located in the pixel region and spaced apart from the gate line 120. Although FIG. 1 illustrates the storage electrode 130 including a portion parallel to the gate line 120 and a portion parallel to the data line 170, exemplary embodiments are not limited thereto. For instance, the storage electrode 130 may be disposed parallel with the gate line 120. A determined voltage, such as a common voltage Vcom, may be applied to the storage electrode 130.

A gate insulating layer 140 is disposed on the gate line 120 and the storage electrode 130. A semiconductor layer 154 is located on the gate insulating layer 140. The semiconductor layer 154 may include, for instance, amorphous silicon (a-Si), polycrystalline silicon (poly-Si), a metal oxide, etc. The source electrode 173 protrudes from the data line 170 and a drain electrode 175 spaced apart from the source electrode 173 are located on the semiconductor layer 154.

The gate electrode 124, the semiconductor layer 154, the source electrode 173, and the drain electrode 175 form a thin film transistor (TFT). A channel of the TFT is disposed in a partial region of the semiconductor layer 154; that is, a region between the source electrode 173 and the drain electrode 175. When the TFT is in an on-state, a data signal applied to the source electrode 173 is transferred to the drain electrode 175. The data line 170, the source electrode 173, and the drain electrode 175 are covered with an insulating layer 180.

A pixel electrode 190 is disposed on the insulating layer 180 and corresponds to a pixel region. The pixel electrode 190 is electrically connected with the TFT via a contact hole 185 formed in the insulating layer 180. When the TFT is in an on-state, the pixel electrode 190 receives a data signal from the drain electrode 175. The pixel electrode 190 may include a transparent conductive material, such as aluminum zinc oxide (AZO), gallium zinc oxide (GZO), indium tin oxide (ITO), indium zinc oxide (IZO), etc. It is also contemplated that one or more conductive polymers (ICP) may be utilized, such as, for example, polyaniline (PANI), poly(3,4-ethylenedioxythiophene) poly(styrenesulfonate) (PEDOT:PSS), etc.

The pixel electrode 190 may include a horizontal stem portion 190a, a vertical stem portion 190b crossing the horizontal stem portion 190a and branch portions 190c. According to one or more exemplary embodiments, the pixel region may be divided into four sub-regions by the horizontal stem portion 190a and the vertical stem portion 190b. To this end, each sub-region may include the branch portions 190c. Exemplary embodiments, however, are not limited to the aforementioned configuration of the pixel electrode 190. The pixel electrode 190 may also include an extension portion 190d extending from the pixel region. The extension portion 190d is electrically connected with the drain electrode 175 via the contact hole 185 formed in the insulating layer 180.

A light-shielding member 220 includes a material through which light cannot pass, such as carbon black, chromium, etc. The light-shielding member 220 includes a first light-shielding portion 220a that extends along the first direction D1 and overlaps the gate line 120. The first light-shielding portion 220a has a determined width that overlaps not only the gate line 120, but also a portion of the pixel electrode 190; for example, the extension portion 190d of the pixel electrode 190. The light-shielding member 220 may also include a second light-shielding portion 220b that extends along the second direction D2 to cross the first light-shielding portion 220a. The second light-shielding portion 220b may be integrally formed with the first light-shielding portion 220a. Although FIGS. 1 to 4 illustrate the light-shielding member 220 including the first light-shielding portion 220a and the second light-shielding portion 220b with the pixel region being surrounded by the light-shielding member 220, exemplary embodiments are not limited thereto. For instance, the second light-shielding portion 220b may be omitted depending on a design of the pixel region.

A lower alignment layer 11 is disposed on the pixel electrode 190, and an upper alignment layer 21 is disposed under a common electrode 350. The upper alignment layer 21 faces the lower alignment layer 11. The lower alignment layer 11 and the upper alignment layer 21 may include materials, such as polyimide, polyamic acid, polysiloxane, etc. The lower alignment layer 11 and the upper alignment layer 21 may be vertical alignment layers. The lower alignment layer 11 and the upper alignment layer 21 may be connected with each other via a cavity 305, such as illustrated in FIG. 3. As previously mentioned, the upper alignment layer 21 faces the lower alignment layer 11, and the cavity 305 is located between the lower alignment layer 11 and the upper alignment layer 21. The cavity 305 includes a controllable material disposed therein, such as liquid crystal (LC) molecules dropped (or otherwise injected) in cavity 305 via an LC inlet OP. For instance, a material forming the lower alignment layer 11 and the upper alignment layer 21, as well as an LC material including LC molecules may enter cavity 305 through the LC inlet OP (formed in one side of the cavity 305) by way of capillary force (or action).

The common electrode 350 is located on the upper alignment layer 21. The common electrode 350 receives a common voltage Vcom and forms an electric field with the pixel electrode 190 to control a direction in which the LC molecules are aligned. A partial region of the common electrode 350 corresponding to the LC inlet OP is open so that the LC molecules may be dropped into the cavity 305 via the LC inlet OP. The common electrode 190 may include a transparent conductive material, such as aluminum zinc oxide (AZO), gallium zinc oxide (GZO), indium tin oxide (ITO), indium zinc oxide (IZO), etc. It is also contemplated that one or more conductive polymers (ICP) may be utilized, such as, for example, polyaniline (PAM), poly(3,4-ethylenedioxythiophene) poly(styrenesulfonate) (PEDOT:PSS), etc.

A roof layer 360 is located on the common electrode 350. The roof layer 360 includes color filters 360R, 360G, and 360B. For instance, the roof layer 360 may include red, green, and blue color filters 360R, 360G, and 360B, but exemplary embodiments are not limited thereto. For example, the roof layer 360 may include cyan, magenta, and yellow color filters, or any other suitable color.

The cavity 305 is formed between the pixel electrode 190 and the common electrode 350 by the roof layer 360. The roof layer 360 includes a partition wall 363 that partially surrounds the pixel region. The partition wall 363 may be disposed along the edge of the pixel region except a side of the pixel region in which the LC inlet OP is formed.

A cover layer 370 is located on the roof layer 360. The cover layer 370 covers the LC inlet OP. The cover layer 370 seals the LC inlet OP so that the LC molecules disposed inside the cavity 305 do not leak out to the outside. Since the cover layer 370 contacts the LC molecules, the cover layer 370 may include a material that does not react with the LC molecules, such as parylene. The cover layer 370 may include a single layer or multiple layers. When the cover layer 370 includes multiple layers, the layers may include different materials, respectively. For example, the cover layer 370 may include a layer including an organic insulating material and a layer including an inorganic insulating material.

With continued reference to FIGS. 1 to 4, the roof layer 360 includes pillar portions 361 and 362. The partition wall 363 is not formed on one side of the roof layer 360 in which the LC inlet OP is formed, and the pillar portions 361 and 362 that support the roof layer 360 are located on the one side of the roof layer 360. The pillar portions 361 and 362 may be spaced apart from each other. The pillar portions 361 and 362 extend toward the light-shielding member 220. Although FIGS. 1 to 4 illustrate two pillar portions 361 and 362, exemplary embodiments are not limited thereto. For instance, three or more pillar portions or one pillar portion may be provided depending on, for example, the size of the pixel region.

The first light-shielding portion 220a includes protrusion portions 221 and 222 respectively corresponding to the pillar portions 361 and 362 of the roof layer 360. As illustrated in FIG. 4, the first thickness t1 (measured in a third direction D3) of a first region A1 of the first light-shielding portion 220a that includes the protrusion portions 221 and 222 is different from the second thickness t2 (measured in the third direction D3) of a second region A2 of the first light-shielding portion 220a that does not include the protrusion portions 221 and 222. The first thickness t1 of the first region A1 of the first light-shielding portion 220a that includes the protrusion portions 221 and 222 may be greater than the second thickness t2 of the second region A2 of the first light-shielding portion 220a that does not include the protrusion portions 221 and 222. The second region A2 of the first light-shielding portion 220a is adjacent to the first region A1 and forms the LC inlet OP, which is described in more detail later.

The common electrode 350 is located on the inner surface of the roof layer 360; that is, on a first side facing the pixel electrode 190. Since the roof layer 360 includes the pillar portions 361 and 362, a portion of the common electrode 350 is located on the lower surfaces of the pillar portions 361 and 362. In this manner, a first distance H1 (see FIG. 4) in the third direction D3 between the pixel electrode 190 and portions of the common electrode 350 that are located on the pillar portions 361 and 362 is less than a second distance H2 (see FIG. 3) in the third direction D3 between the pixel electrode 190 and a portion of the common electrode 350 that are spaced apart from each other with the cavity 305 disposed therebetween. The light-shielding member 220, for example, the protrusion portions 221 and 222 of the first light-shielding portion 220a are disposed between the portions of the common electrode 350 that are located on the pillar portions 361 and 362 and the pixel electrode 190. In this manner, the protrusion portions 221 and 222 of the first light-shielding portion 220a electrically insulate the common electrode 350 from the pixel electrode 190.

The first light-shielding portion 220a may prevent (or at least reduce) an electrical short circuit between the common electrode 350 and the pixel electrode 190, as well as prevent (or at least reduce) defective dropping of the LC molecules via the LC inlet OP by including the first region A1 and the second region A2 respectively having different thicknesses. The first thickness t1 of the first region A1 of the first light-shielding portion 220a that includes the protrusion portions 221 and 222 may be greater than the second thickness t2 of the second region A2 to prevent an electrical short circuit between the common electrode 350 and the pixel electrode 190. The second thickness t2 of the second region A2 of the first light-shielding portion 220a that forms the LC inlet OP may be less than the first thickness t1 of the first region A1 to increase a distance between the first light-shielding portion 220a and the roof layer 360; that is, the height of the LC inlet OP.

When the first thickness t1 of the first light-shielding portion 220a is uniform, the height of the LC inlet OP reduces, and, as such, a defective dropping issue involving a material forming the upper alignment layer 21 and the lower alignment layer 11 and an LC material forming the LC molecules may not be properly dropped. To resolve (or address) the defective dropping of the alignment material and the LC material, the second thickness t2 of the first light-shielding portion 220a may be uniform. However, when the second thickness t2 of the first light-shielding portion 220a is small, the first light-shielding portion 220a may have insufficient second thickness t2 for suppressing light leakage, and the distance between the common electrode 350 and the pixel electrode 190 may be insufficient to prevent a short circuit between the common electrode 350 and the pixel electrode 190.

In contrast, according to one or more exemplary embodiments, the first thickness t1 of the first region A1 and the second thickness t2 of the second region A2 are different from each other. In this manner, defective dropping of the LC material may be resolved, light leakage may be suppressed, and a short circuit between the common electrode 350 and the pixel electrode 190 may be prevented.

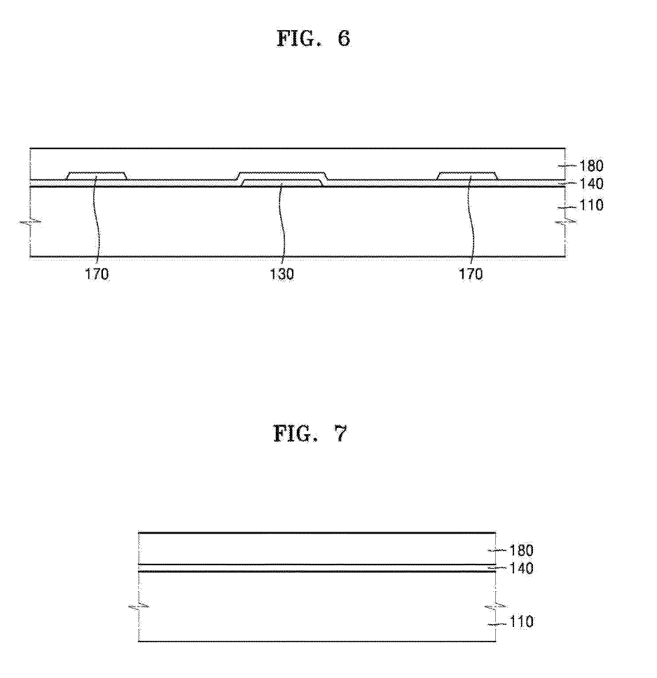

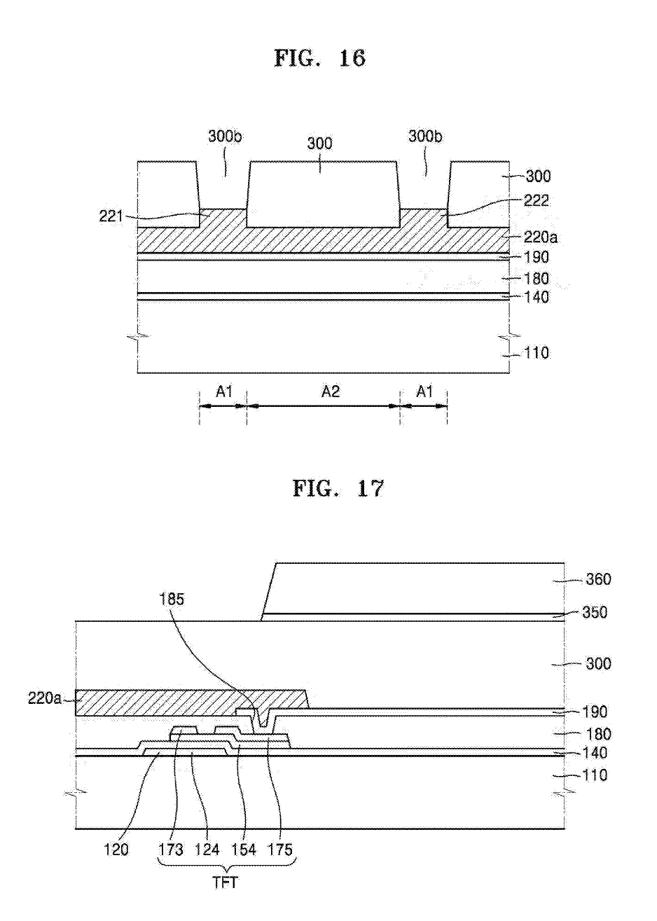

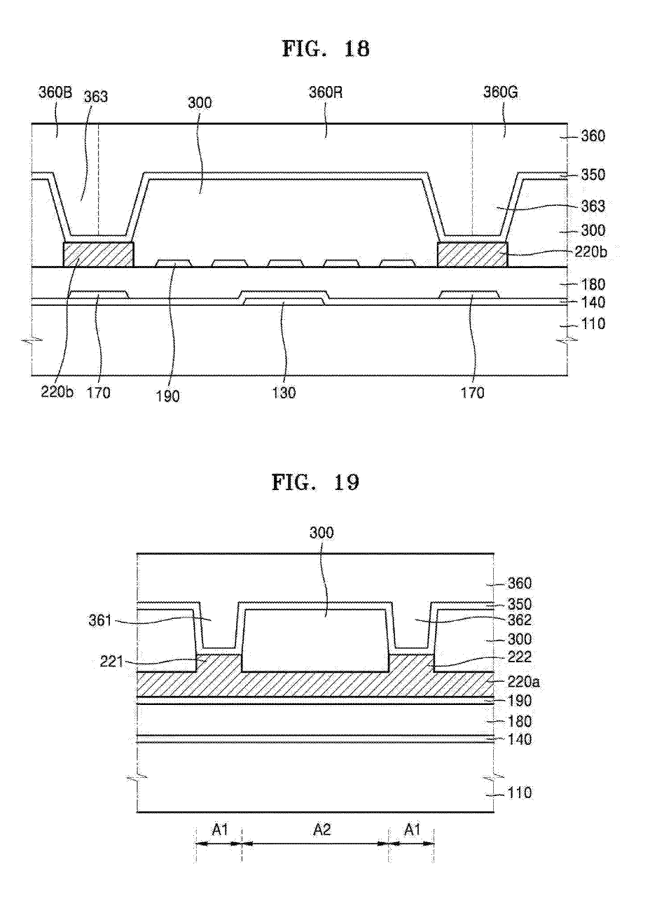

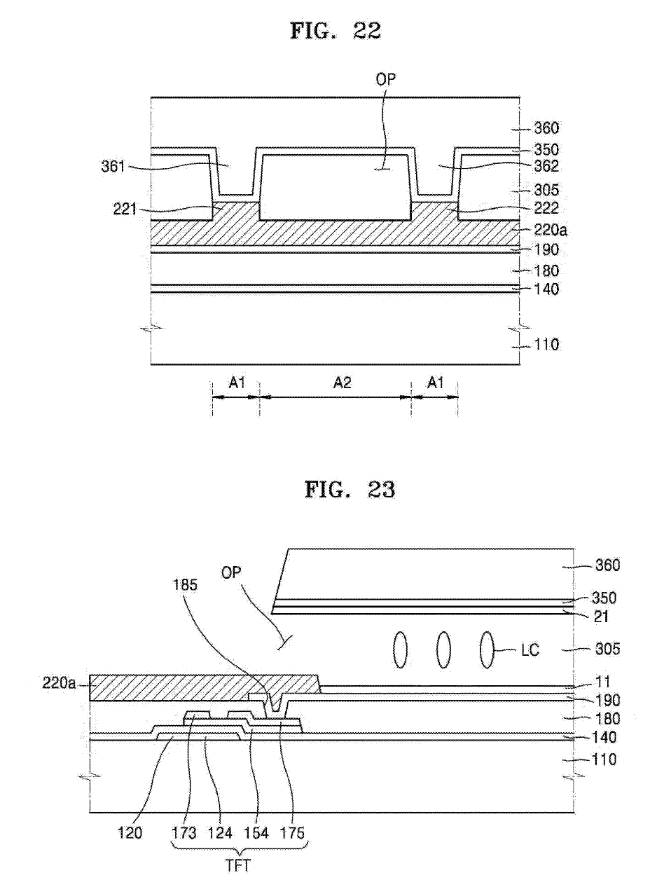

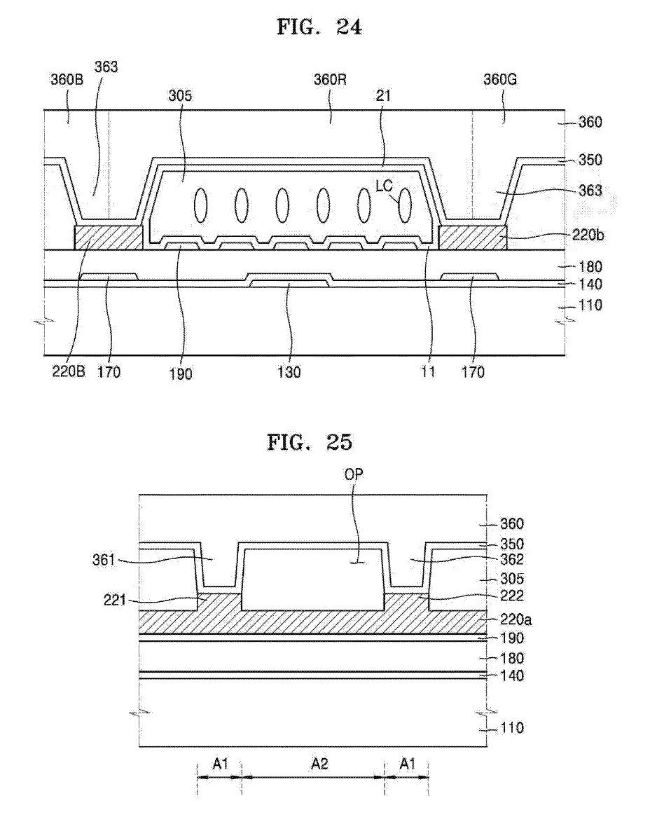

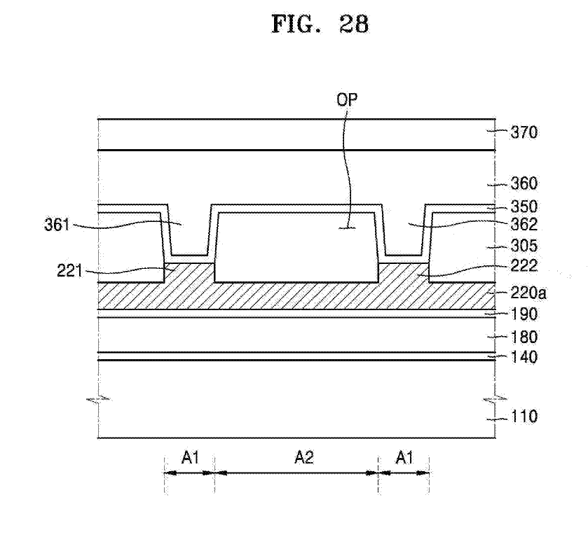

FIGS. 5 to 28 are respective cross-sectional views of a pixel at various stages of manufacture, according to one or more exemplary embodiments. FIGS. 5, 8, 11, 14, 17, 20, 23, and 26 are respective cross-sectional views taken along the same sectional line. FIGS. 6, 9, 12, 15, 18, 21, 24, and 27 are respective cross-sectional views taken along the same sectional line, which is different than the sectional line associated with FIGS. 5, 8, 11, 14, 17, 20, 23, and 26. FIGS. 7, 10, 13, 16, 19, 22, 25, and 28 are cross-sectional views taken along the same sectional line different than the sectional lines of FIGS. 5, 8, 11, 14, 17, 20, 23, and 26 and FIGS. 6, 9, 12, 15, 18, 21, 24, and 27.

Referring to FIGS. 5 to 7, the gate line 120 and the gate electrode 124 that protrudes from the gate line 120 are formed on the substrate 110 including a glass material or a plastic material. The storage electrode 130 is formed during the same process as forming the gate line 120. The gate insulating layer 140 is formed on the gate line 120 and the storage electrode 130. The semiconductor layer 154 is formed on the gate insulating layer 140. The semiconductor layer 154 may be formed by depositing a semiconductor material, such as amorphous silicon (a-Si), polycrystalline silicon (poly-Si), a metal oxide, etc., and then patterning the deposited semiconductor material.

The data line 170, the source electrode 173 that extends from the data line 170, and the drain electrode 175 spaced apart from the source electrode 173 are formed by forming a metallic layer on the semiconductor layer 154 and patterning the metallic layer. The data line 170, the source electrode 173, and the drain electrode 175 are formed in the same layer during the same process. The gate electrode 124, the semiconductor layer 154, the source electrode 173, and the drain electrode 175 form the TFT. The insulating layer 180 is formed on the TFT. The contact hole 185 is formed in the insulating layer 180 to expose the drain electrode 175.

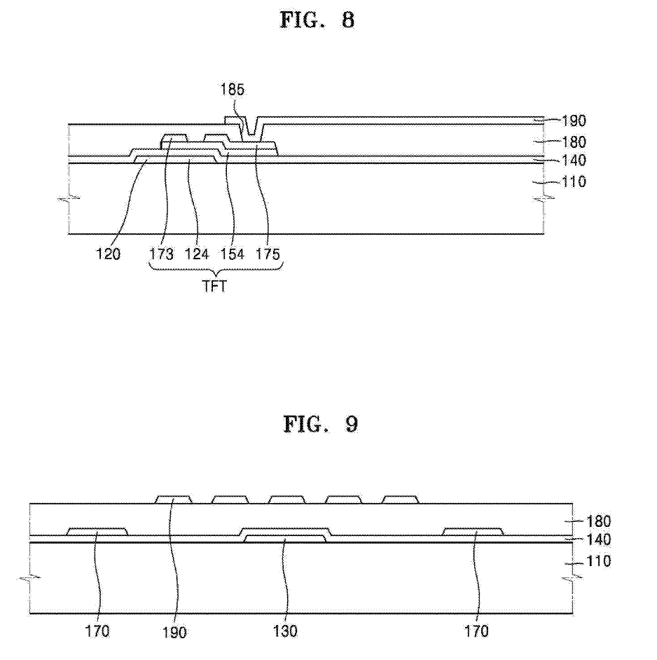

Referring to FIGS. 8 to 10, the pixel electrode 190 is formed on the insulating layer 180. The pixel electrode 190 is formed by depositing a transparent conductive material layer including, for instance, AZO, GZO, ITO, and/or IZO on the insulating layer 180, and then patterning the transparent conductive material layer. The pixel electrode 190 is electrically connected to the drain electrode 175 via the contact hole 185. The pixel electrode 190 may be electrically connected to the drain electrode 175 via the extension portion 190d as described above with reference to FIG. 1. Furthermore, the pixel electrode 190 may include the horizontal stem portion 190a, the vertical stem portion 190b that crosses the horizontal stem portion 190a, and the branch portions 190c as described above with reference to FIG. 1.

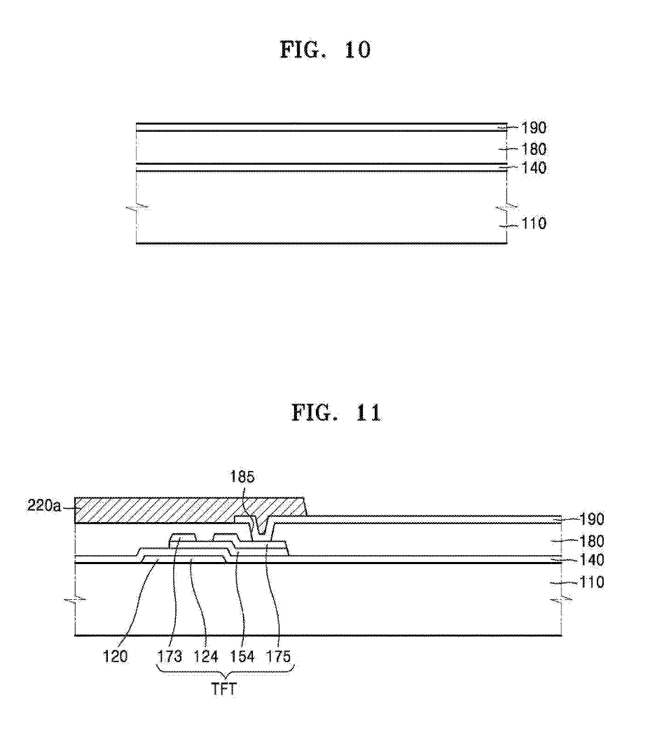

Referring to FIGS. 11 to 13, the light-shielding member 220 is formed on the pixel electrode 190. The light-shielding member 220 is formed by coating a light-blocking material, such as carbon black, and then patterning the light-blocking material. The light-shielding member 220 may be patterned to include the first light-shielding portion 220a that extends along the first direction D1 and overlaps the gate line 120, and the second light-shielding portion 220b that extends along the second direction D2 to cross the first light-shielding portion 220a. The first light-shielding portion 220a has a determined width to overlap not only the gate line 120, but also a portion of the pixel electrode 190, for example, the extension portion 190d of the pixel electrode 190. The second light-shielding portion 220b may be integrally formed with the first light-shielding portion 220a.

The first light-shielding portion 220a includes the protrusion portions 221 and 222. The first thickness t1 of the first region A1 of the first light-shielding portion 220a that includes the protrusion portions 221 and 222 is greater than the second thickness t2 of the second region A2 of the first light-shielding portion 220a that does not include the protrusion portions 221 and 222. According to one or more exemplary embodiments, the protrusion portions 221 and 222 that correspond to the first region A1 of the first light-shielding portion 220a are spaced apart from each other, and the second region A2 of the first light-shielding portion 220a that corresponds to a region between the protrusion portions 221 and 222 forms the LC inlet OP.

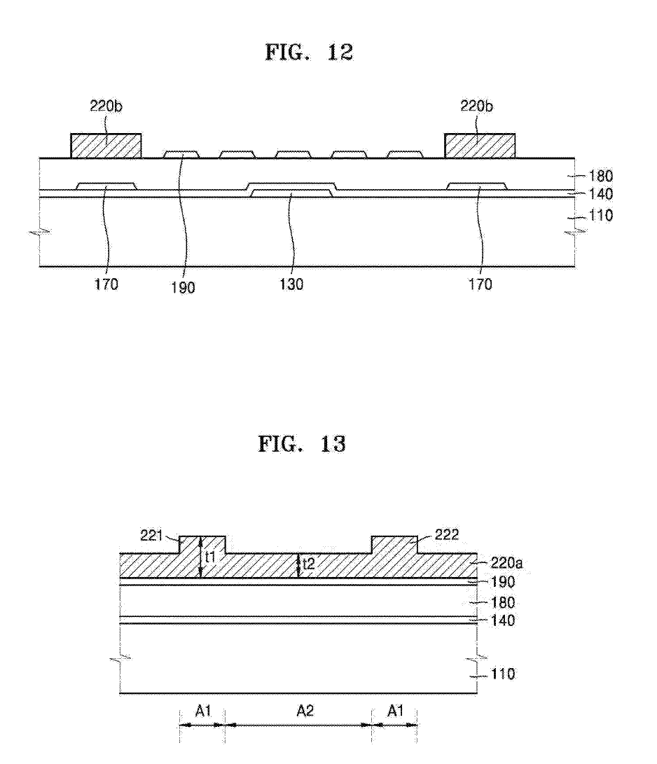

Although the thickness of the second light-shielding portion 220b may be the same as the second thickness t2 of the second region A2 as illustrated in FIG. 12, exemplary embodiments are not limited thereto. For instance, when a portion of the pixel electrode 190 is disposed under the second light-shielding portion 220b, the thickness of the second light-shielding portion 220b may be the same as the first thickness t1 of the first region A. Moreover, although exemplary embodiments have been described in association with the light-shielding member 220 including the first and second light-shielding portions 220a and 220b, exemplary embodiments are not limited thereto. For instance, the second light-shielding portion 220b may be omitted depending on a design of the pixel region.

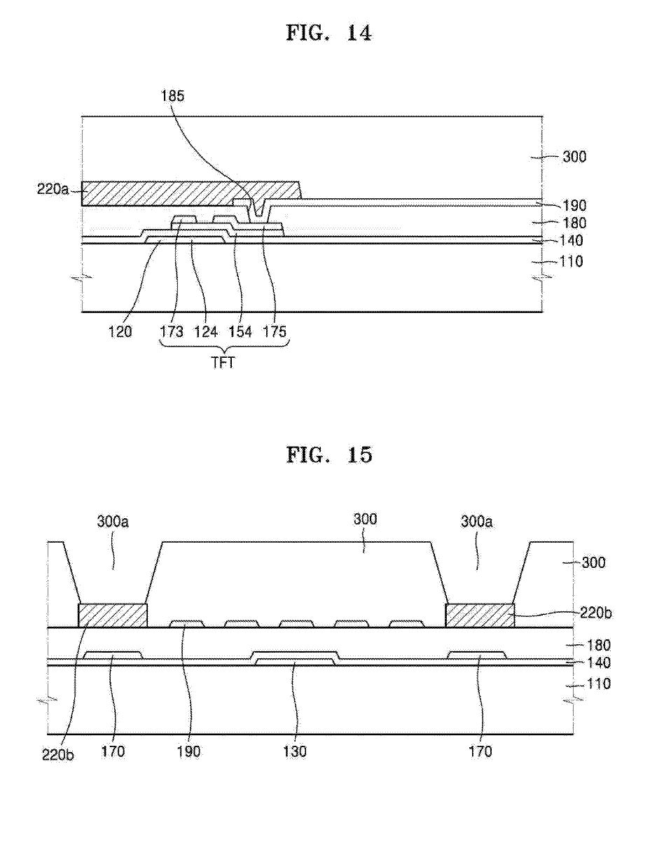

Referring to FIGS. 14 to 16, a sacrificial layer 300 including an organic insulating material is formed on the pixel electrode 190 and the light-shielding member 220. The sacrificial layer 300 may include a photosensitive polymer material. The sacrificial layer 300 may be patterned via a photolithographic process. The patterned sacrificial layer 300 includes a first through-hole 300a that partially surrounds the pixel region and a second through-hole 300b that corresponds to the protrusion portions 221 and 222 disposed in the first region A1 of the first light-shielding portion 220a.

Referring to FIGS. 17 to 19, the common electrode 350 and the roof layer 360 are formed on the sacrificial layer 300. The common electrode 350 may be formed by depositing a transparent metallic material, AZO, GZO, ITO, and/or IZO, and then patterning the deposited transparent metallic material. The common electrode 350 is formed above the sacrificial layer 300, and formed on the inner surfaces of the first and second through-holes 300a and 300b. The common electrode 350 is not formed on one side of the pixel region, which enables a portion of the sacrificial layer 300 to be exposed to the outside.

The roof layer 360 is formed on the common electrode 350 and includes color filters 360R, 360G, and 360B of three colors. According to one or more exemplary embodiments, the roof layer 360 may be formed by forming a blue roof layer 360B, shifting a mask to form a red roof layer 360R, and then shifting the mask to form a green roof layer 360G. Although exemplary embodiments have been described with the roof layer 360 including the red, green, and blue color filters 360R, 360G, and 360B, exemplary embodiments are not limited thereto. For instance, the roof layer 360 may include color filters of cyan, magenta, and yellow colors, and/or any other suitable color.

A material forming the roof layer 360 fills the inside of the first and second through-holes 300a and 300b of the sacrificial layer 300 to form the partition wall 363 and the pillar portions 361 and 362. The pillar portions 361 and 362 are located on one side of the roof layer 360, face the protrusion portions 221 and 222, and stably support the roof layer 360. The roof layer 360 may be patterned, such that the roof layer 360 is not formed on a region of the sacrificial layer 300 in which the common electrode 350 is not formed, as seen in FIG. 17.

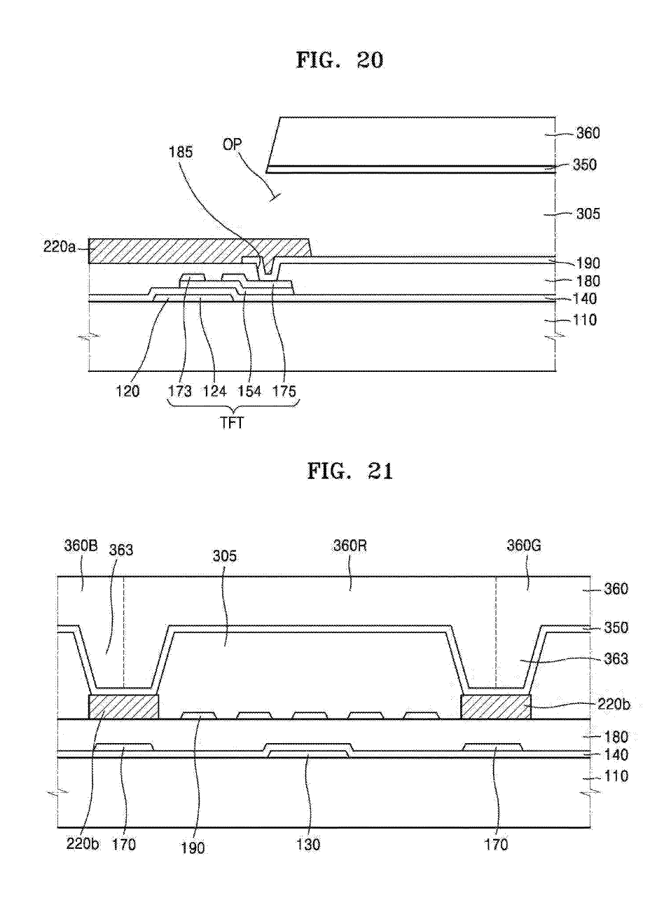

Referring to FIGS. 20 to 22, the sacrificial layer 300 is removed using, for instance, oxygen plasma or a developer. The cavity 305 is formed by the removal of the sacrificial layer 300. The cavity 305 may maintain its shape by way of the roof layer 360. The cavity 305 is partially surrounded by the partition wall 363 of the roof layer 360. One side of the roof layer 360 that does not include the partition wall 363 is open. The opening forms the LC inlet OP. The cavity 305 is spatially connected with the outside via the LC inlet OP. The LC inlet OP is disposed adjacent to the pillar portions 361 and 362. One side of the roof layer 360 that includes the LC inlet OP is supported by the pillar portions 361 and 362.

Referring to FIGS. 23 to 25, alignment liquid is dropped into the cavity 305 via the LC inlet OP. After the alignment liquid is dropped and a baking process is performed, a solution component evaporates and an alignment material remains on the inner lateral wall of the cavity 305 to form the lower alignment layer 11 and the upper alignment layer 21. The lower alignment layer 11 and the upper alignment layer 21 are disposed facing each other with the cavity 305 disposed therebetween. The edges of the lower alignment layer 11 and the upper alignment layer 21 are connected with each other. The lower alignment layer 11 and the upper alignment layer 21 (except a portion corresponding to the edge of the cavity 305) are aligned in a direction perpendicular to the substrate 110. After formation of the lower alignment layer 11 and the upper alignment layer 21, an LC material including LC molecules is dropped via the LC inlet OP using, for instance, an inkjet process, etc. The LC material may enter the cavity 305 according to a capillary action (or force).

As illustrated in FIG. 25, the thickness of the first region A1 of the first light-shielding portion 220a that includes the protrusion portions 221 and 222 and the thickness of the second region A2 of the first light-shielding portion 220a are formed different. In this manner, defective dropping of the LC material may be resolved, light leakage may be suppressed, and a short circuit between the common electrode 350 and the pixel electrode 190 may be prevented.

The first thickness t1 (see FIG. 4) of the first region A1 of the first light-shielding portion 220a that includes the protrusion portions 221 and 222 is formed greater than the second thickness t2 (see FIG. 4) of the second region A2 of the first light-shielding portion 220a to increase a distance between the common electrode 350 and the pixel electrode 190. In this manner, an electrical short circuit may be prevented. Also, the second thickness t2 of the second region A2 of the first light-shielding portion 220a that forms the LC inlet OP is formed less thick than the first thickness t1 of the first region A1 to increase a distance between the first light-shielding portion 220a and the roof layer 360; that is, the height of the LC inlet OP. As such, defective dropping of the LC material may be prevented (or at least reduced).

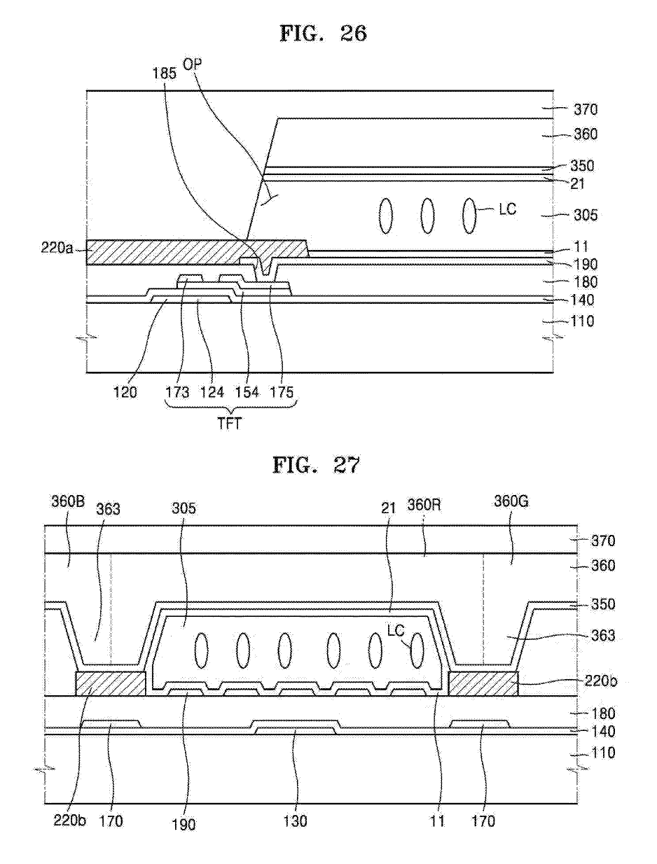

Referring to FIGS. 26 to 28, the cover layer 370 is formed. The cover layer 370 may include a material that does not react with the LC molecules, such as parylene. The cover layer 370 covers the LC inlet OP and seals the cavity 305. The cover layer 370 may include a single layer or multiple layers. When the cover layer 370 includes multiple layers, the multiple layers may include different materials, respectively. For example, the cover layer 370 may include a layer including an organic insulating material and a layer including an inorganic insulating material.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A display device, comprising:
a pixel electrode disposed in a pixel region;
a light-shielding member partially overlapping the pixel electrode;
a roof layer facing the pixel electrode, the roof layer comprising:
a color filter; and
a pillar portion extending toward the light-shielding member;
a cavity formed between the pixel electrode and the roof layer;
a common electrode disposed on the roof layer;
an inlet exposing a portion of the cavity;
a controllable material disposed in the cavity; and
a cover layer sealing the inlet,
wherein the light-shielding member comprises:
a first region corresponding to the pillar portion; and
a second region adjacent to the first region, and
wherein a thickness of the first region is different from a thickness of the second region.

2. The display device of claim 1, wherein the first region overlaps the pixel electrode.

3. The display device of claim 1, wherein the inlet is adjacent to the pillar portion.

4. The display device of claim 1, wherein:
the pillar portion comprises a first pillar portion spaced apart from and a second pillar portion;
the first region corresponds to the first pillar portion and the second pillar portion; and
the second region corresponds to a space between the first pillar portion and the second pillar portion.

5. The display device of claim 1, wherein the thickness of the first region is greater than the thickness of the second region.

6. The display device of claim 1, wherein:
the pillar portion comprises a surface facing the light-shielding member; and
a portion of the common electrode is disposed on the surface.

7. The display device of claim 1, further comprising:
a gate line extending along a first direction; and
a data line extending along a second direction crossing the first direction,
wherein:
the light-shielding member comprises a first light-shielding portion overlapping the gate line, the first light-shielding portion extending along the first direction; and
the first light-shielding portion comprises the first region and the second region.

8. The display device of claim 7, wherein the light-shielding member further comprises:
a second light-shielding portion crossing the first light-shielding portion, the second light-shielding portion overlapping the data line.

9. A display device, comprising:
a pixel electrode disposed in a pixel region;
a light-shielding member partially overlapping the pixel electrode;
a roof layer facing the pixel electrode, the roof layer comprising a pillar portion extending toward the light-shielding member;
a cavity formed between the pixel electrode and the roof layer;
a common electrode disposed on the roof layer; and
a controllable material disposed in the cavity,
wherein the light-shielding member comprises a protrusion portion protruding toward the pillar portion.

10. The display device of claim 9, wherein a portion of the common electrode is disposed between the pillar portion and the protrusion portion.

11. The display device of claim 9, wherein:
the pillar portion comprises a first pillar portion and a second pillar portion spaced apart from one another; and
the protrusion portion comprises a first protrusion portion and a second protrusion portion that respectively correspond to the first pillar portion and the second pillar portion.

12. The display device of claim 11, further comprising:
an inlet to the cavity, the inlet being disposed between the first pillar portion and the second pillar portion.

13. The display device of claim 12, wherein a thickness of a first portion of the light-shielding member disposed in correspondence with the inlet is less thick than a thickness of a second portion of the light-shielding member disposed in correspondence with the protrusion portion.

14. The display device of claim 12, further comprising:
a cover layer sealing the inlet.

15. The display device of claim 9, wherein the roof layer further comprises:
a lateral wall partially surrounding the cavity.

16. The display device of claim 9, further comprising:
a substrate, the pixel electrode being disposed on the substrate;
a gate line disposed on the substrate, the gate line extending along a first direction; and
a data line disposed on the substrate, the data line extending along a second direction crossing the first direction,
wherein:
the light-shielding member comprises a first light-shielding portion overlapping the gate line, the first light-shielding portion extending along the first direction; and
the protrusion portion is disposed on the first light-shielding portion.

17. The display device of claim 16, wherein the light-shielding member further comprises a second light-shielding portion crossing the first light-shielding portion, the second light-shielding portion overlapping the data line.

18. The display device of claim 17, wherein the first light-shielding portion and the second light-shielding portion are integrally formed with one another as one body.

19. The display device of claim 9, wherein the controllable material comprises liquid crystal.

20. The display device of claim 1, wherein the controllable material comprises liquid crystal.
